(19) United States
(12) Patent Application Publication
(10) Pub. No.: US 2014/0112307 A1
(43) Pub. Date: Apr. 24, 2014

(54) USER TERMINAL AND COMMUNICATION APPARATUS FOR PREVENTING INTERUPTION OF COMMUNICATION IN INFORMATION CENTRIC NETWORK AND METHOD THEREOF

(71) Applicant: ELECTRONICS AND TELECOMMUNICATIONS RESEARCH INSTITUTE, Daejeon-si (KR)

(72) Inventors: Jong-Hwan KIM, Daejeon-si (KR); Chang-Woo YOON, Daejeon-si (KR); Do-Hyung KIM, Daejeon-si (KR); Ik-Jun YEOM, Gyeonggi-do (KR)

(73) Assignee: ELECTRONICS AND TELECOMMUNICATIONS RESEARCH INSTITUTE, Daejeon-si (KR)

(21) Appl. No.: 14/054,359

(22) Filed: Oct. 15, 2013

(30) Foreign Application Priority Data
Oct. 19, 2012 (KR) 10-2012-0116922
Jul. 24, 2013 (KR) 10-2013-0087585

(51) Int. Cl. H04W 36/00

(52) U.S. Cl. CPC H04W 36/0061
USPC 370/331

(57) ABSTRACT

A user terminal for preventing communication interruption during handoff in an information-centric network is provided. The user terminal includes a connection registration unit configured to register the user terminal in an access node for connection to the access node, and a communication interruption prevention unit configured to receive, from the access node in which the user terminal is registered, zone information including identification information on other access nodes that are candidate handoff targets of the user terminal, and transfer the zone information to a counterpart communication device that currently performs communication, wherein the user terminal receives a message from the counterpart communication device through one of the other access nodes that are candidate handoff targets during the handoff. Accordingly, communication interruption is prevented.

### CROSS-REFERENCE TO RELATED APPLICATION

This application claims priority from Korean Patent Application Nos. 10-2012-0116922, filed on Oct. 19, 2012, and 10-2013-0087585, filed on Jul. 24, 2013, in the Korean Intellectual Property Office, the disclosures of which are incorporated herein by references for all purposes.

### BACKGROUND

1. Field

The following description relates to an information centric network (ICN) for providing a service based on a name of content, and more particularly, to technology related to handoff of a user terminal in an ICN.

2. Description of the Related Art

In an ICN, a terminal uses a P2P application-type network communication method in which a name of content is directly used to request the content. This method is different from a conventional URL method in which content is requested with an address of a host possessing the content. Research into P2P application-type network communication began after 2009, and research and development of technology has still not progressed very far. Moreover, research into a handoff method has only recently started.

ICNs will be described with reference to a publication entitled “A Survey of Information-Centric Networking” published in the IEEE Communications Magazine in July, 2012. In a conventional IP network, a request for content is made using a server host address such as ftp://123.211.222.112/movie127.avi and a content name, based on a host name. A representative example of such a method is an FTP web method in which an address is used as mentioned above. According to this method, content should always be received from a corresponding host server, causing a scalability bottleneck of the server.

To overcome this limitation, a name of content is directly used as an address in an ICN to request the content, instead of a host address of the content. For example, the request is made using a command such as “Get movie 127.avi”. According to this method, the content may be received from any cache server having “movie 127.avi” without necessarily accessing any specific server. Therefore, the content may be rapidly received from an adjacent cache server and a network load is reduced. This method may be considered to be a combination of a method in which a search for content is made through a P2P application to easily receive the content from an adjacent site and a method in which a request for content is made using a representational state transfer (REST) method such as “Get content_name” through HTTP and a cache server is interposed to facilitate distribution of the content.

In an ICN, when content is requested, a request message for requesting the content is referred to as an ‘interest’, and a data name that is a content name has a hierarchical structure such as ‘Domain/dhkim/File’. For example, if a file-x possessed by dhkim of Etri is transferred, an interest message is sent to a gateway server. Here, in the interest message, a message for requesting ‘Etri/jhkim/file-x’ is included. The interest message is hop-by-hop transported through a routing server according to a predetermined routing algorithm.

FIG. 1 is a diagram illustrating a process of transferring an interest message when a user terminal makes a request for content. A requested content name is referred to as ‘Dmain1/dhkim/file’. The interest message arrives at a destination through routers R1, R2, and R3, and the content is downloaded to a user terminal 10. Here, as illustrated in FIG. 1, an intermediate router refers to a routing table, i.e., a forwarding information base (FIB), to perform routing using domain information of a corresponding interest, and records information in a pending interest table with respect to a transferred interest so that the information is referred to when a response message is sent. This method is frequently used for a content centric network, which is one type of ICN, and may differ according to type of ICN.

When the message for requesting the content arrives at a server 20 having the requested content name, response data for the content is transferred to the user terminal 10. Here, intermediate nodes that transfer the response data store, as necessary, the response data in a caching format in storages of the nodes. Due to this operation, an intermediate node is enabled to directly respond, when the same content is requested later. It is highly likely for content that is frequently requested by users to be cached by intermediate routers in a network. Therefore, responses may be received from the intermediate nodes even though the interest is not transferred to an original source server that is remotely located. Therefore, a network load is reduced and a download speed of the content increases.

In a conventional IP network, which is not an ICN, mobility of a mobile terminal is supported by a mobile IP method. Here, according to the mobile IP method, a management server, i.e., a home agent, is provided, wherein the home agent monitors mobility information on a mobile terminal and relays a packet of the mobile terminal when the mobile terminal moves. Handoff methods suggested for the ICN are the same as conventional handoff methods, and thus all packets are relayed through a single relay server. It has been suggested to repackage and transfer all packets to a movement location of a terminal by means of the relay server when the terminal moves.

FIG. 2 is a diagram illustrating a movement scenario of a user terminal in an exemplary connection network structure. In FIGS. 2, R1, R2, and R3 are intermediate relay router nodes. It is assumed that a user terminal 10 is connected to an access node and then moves to the node R3. One example of the movement scenario is a case where a user having a smart phone using a 4G network travels in an automobile at high speed and the smart phone is handed off from one base station to another base station. Another example of the movement scenario is a case where a user of a smart phone using WiFi moves on foot and the smart phone is automatically handed to off from one WiFi access node to another WiFi access node.

According to the movement scenario illustrated in FIG. 2, when the user terminal transfers the interest at a first domain Domain1 and moves to a second domain Domain2, a response message is received via the router R2 that is associated with the first domain Domain1. Therefore, the user terminal cannot receive the response message. The user terminal that has failed to receive the response message transmits a reissued interest at the second domain Domain2, and then receives the response message via the router R3 that is associated with the second domain Domain2. That is, the user terminal retransmits the interest since the user terminal fails to receive the response to the initial interest, and thus a data connection is temporarily released. This handoff process generally requires a time of 200 msec or more. However, in the case of a real-time call application such as VoIP, communication interruption for 200 msec or more may fatally degrade the quality of a call service.

### SUMMARY

The following description relates to technology for preventing service interruption even though a user terminal performs handoff in an information-centric network.

In one general aspect, a user terminal for preventing communication interruption during handoff in an information-centric network includes a connection registration unit configured to register the user terminal in an access node for connection to the access node, and a communication interruption prevention unit configured to receive, from the access node in which the user terminal is registered, zone information including identification information on other access nodes that are candidate handoff targets of the user terminal, and transfer the zone information to a counterpart communication device that currently performs communication, wherein the user terminal receives a message from the counterpart communication device through one of the other access nodes that are candidate handoff targets during the handoff.

The communication interruption prevention unit may transmit a handoff expectation message to the counterpart communication device.

In another general aspect, a communication device for preventing communication interruption during handoff of a user terminal in an information-centric network includes a zone information management unit configured to receive and manage zone information including identification information on other access nodes that are candidate handoff targets of the user terminal, and a communication interruption prevention unit configured to identify the other access nodes based on the received zone information, and transmit, to the identified other access nodes, a message to be transferred to the user terminal.

The communication interruption prevention unit may transmit the message to be transferred to the user terminal when a handoff expectation message is received from the user terminal.

The communication interruption prevention unit may mark, on the message, a flag indicating flooding when transmitting the message.

In still another general aspect, a method of preventing communication interruption during handoff of a user terminal in an information-centric network includes receiving, from an access node in which the user terminal is registered for connection to the access node, adjacent zone information including identification information on adjacent other access nodes, transferring the received zone information to a counterpart communication device that currently performs communication, and receiving a message from the counterpart communication device through one of the other access nodes identified based on the zone information during the handoff.

The adjacent other access nodes may be adjacent nodes that are candidate handoff targets of the user terminal.

The method may further include transmitting a handoff expectation message to the counterpart communication device.

In still another general aspect, a method of preventing, by a communication device, communication interruption during handoff of a user terminal in an information-centric network includes receiving zone information including identification information on other access nodes that are candidate handoff targets of the user terminal, and transmitting, to the other access nodes identified based on the received zone information, a message to be transferred to the user.

The receiving of the zone information may include receiving the zone information transmitted from the user terminal.

The method may further include receiving a handoff expectation message from the user terminal, wherein the transmitting of the message is performed when the handoff expectation message is received.

The transmitting of the message may include marking, on the message, a flag indicating flooding.

Other features and aspects will be apparent from the following detailed description, the drawings, and the claims.

### BRIEF DESCRIPTION OF THE DRAWINGS

FIG. 1 is a diagram illustrating a process of transferring an interest message when a user terminal makes a request for content.

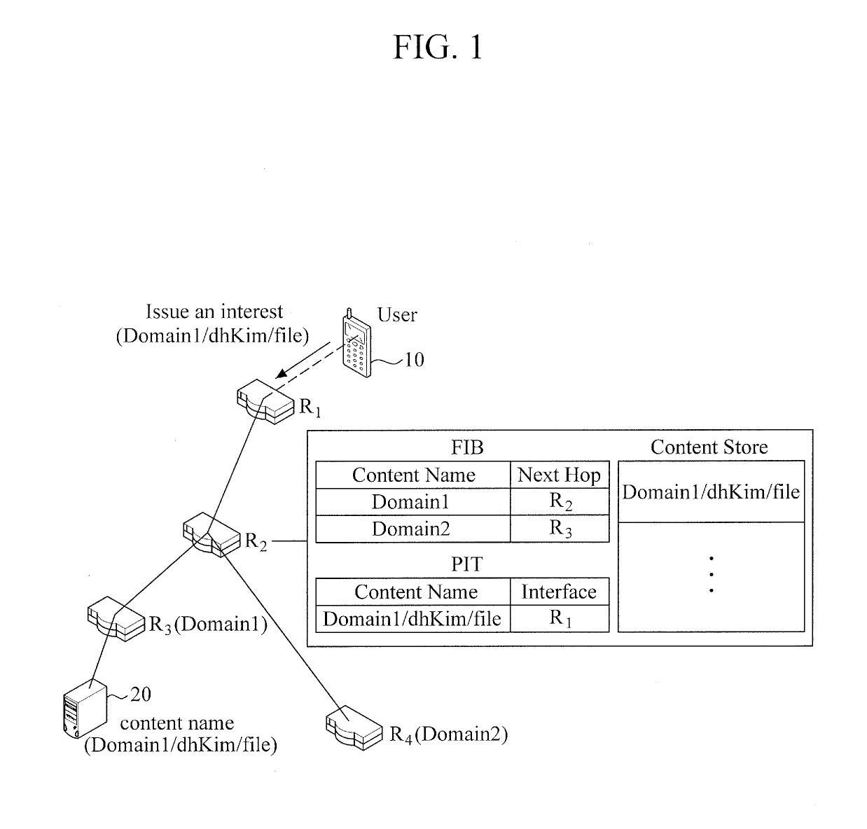

FIG. 2 is a diagram illustrating a movement scenario of a user terminal in an exemplary connection network structure.

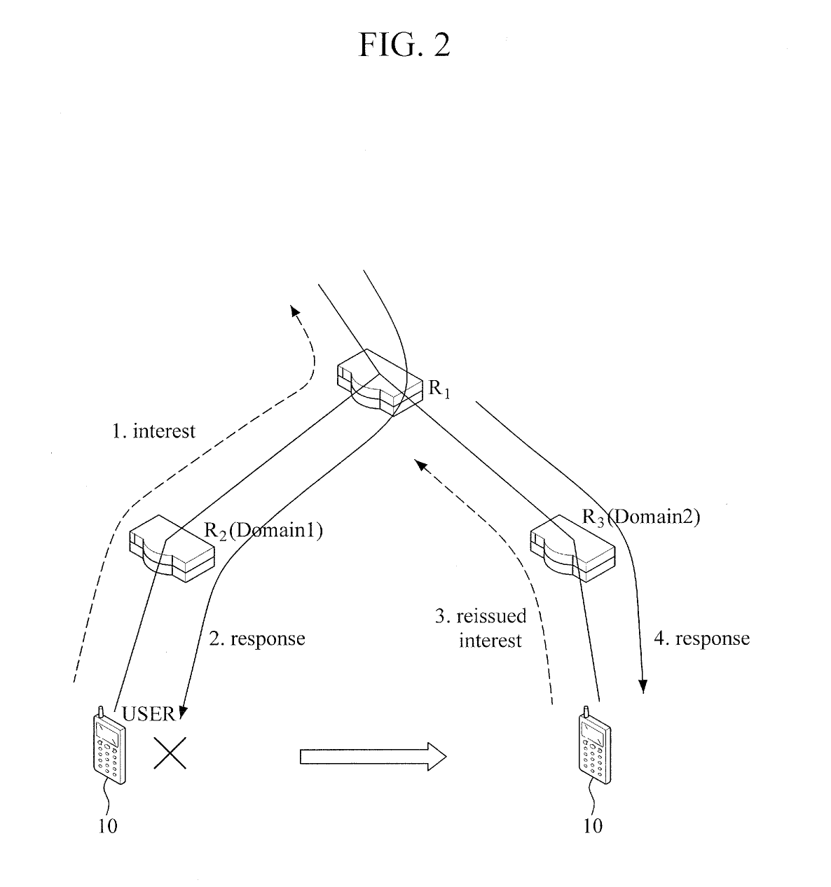

FIG. 3 is a block diagram illustrating a system for preventing communication interruption during handoff of a user terminal.

FIG. 4 is a flowchart illustrating a method of providing, by a user terminal, zone information to a communication device that currently performs communication, according to an embodiment of the present invention.

FIG. 5 is a flowchart illustrating a process during handoff of a user terminal, according to an embodiment of the present invention.

FIG. 6 is a flowchart illustrating a method of receiving and storing, by a communication device, zone information, according to an embodiment of the present invention.

FIG. 7 is a flowchart illustrating a method of transmitting, by a communication device, a message to a user terminal using zone information, according to an embodiment of the present invention.

FIG. 8 is a diagram illustrating a scenario for preventing communication interruption during handoff, according to an embodiment of the present invention.

Throughout the drawings and the detailed description, unless otherwise described, the same drawing reference numerals will be understood to refer to the same respective elements, features, and structures. The relative size and depiction of elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

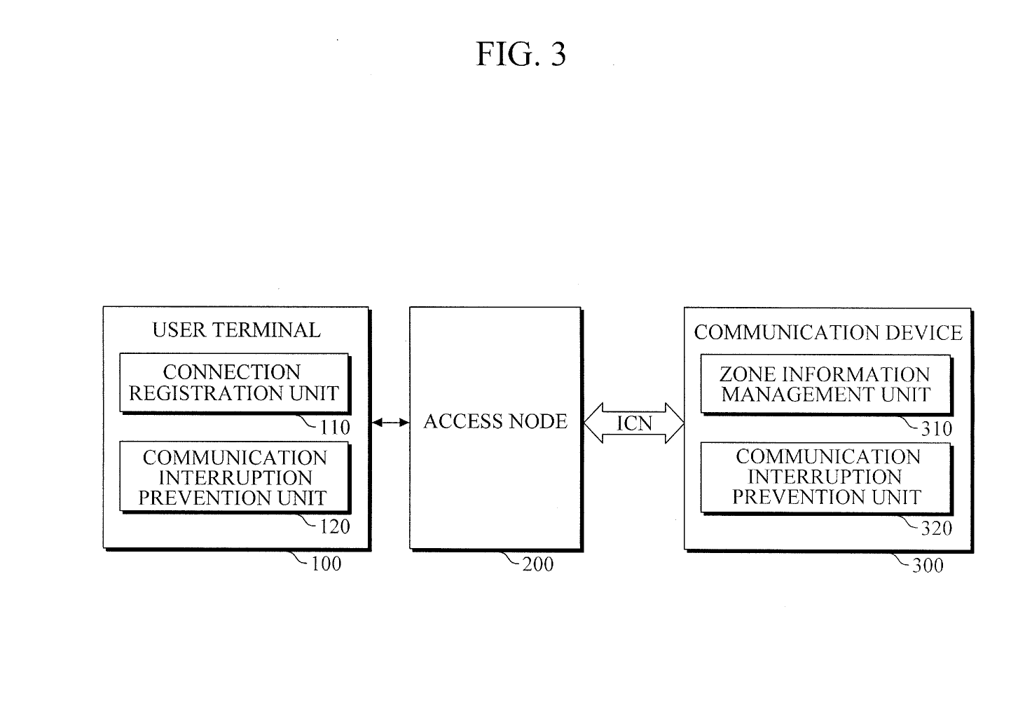

FIG. 3 is a block diagram illustrating a system for preventing communication interruption during handoff of a user terminal.

As illustrated in FIG. 3, the system includes a user terminal 100, an access node 200, and a communication device 300, which may communicate with one another through an ICN. The user terminal 100 is a mobile communication terminal such as a smart phone or a smart pad. The user terminal 100 may access the ICN to request and download content. The access node 200 is an access point for the user terminal 100 and may be an access router. The communication device 300 is capable of communicating with the user terminal through the ICN. The communication device 300 may have content requested by the user terminal 100, and may be an original source server or a router caching and having content possessed by an original source server. The communication device 300 is a communication counterpart of the user terminal 100, and thus may be referred to as a communication counterpart device.

The user terminal 100 includes a connection registration unit 110 and a communication interruption prevention unit 120. The connection registration unit 110 accesses the access node 200 associated with a domain including a location of the user terminal and requests connection registration. Then, the access node registers the user terminal 100. Such a registration process is well known. The communication interruption prevention unit 120 receives adjacent zone information from the access node 200. In one embodiment, the communication interruption prevention unit 120 may receive the adjacent zone information from the access node 200 upon registration in the access node 200.

Here, the adjacent zone information is information on adjacent other access nodes to which the user terminal may be handed off, i.e., information on adjacent other access nodes that are candidate handoff targets of the user terminal 100, and includes identification information on each of the other access nodes. A manager managing the access nodes knows network infra information, and thus may input the zone information to each access node to manage the zone information. The manager may also trace recent records of handoff from adjacent nodes to generate the zone information. The identification information is any information for identifying a node. In one embodiment, the identification information may be a combination of an ID and IP address of a node.

The communication interruption prevention unit 120 transmits the zone information received from the access node 200 to the communication device 300 that currently performs communication, through the access node 200. In this manner, the user terminal 100 receives a message transmitted from the communication device 300 through one of the other access nodes, even though the user terminal 100 is handed off In particular, in the case where the message received from the communication device 300 is a response message for a request from the user terminal 100, the response message may be received without re-request even though handoff occurs, thereby preventing service interruption or instability.

Furthermore, the communication interruption prevention unit 120 may transmit a handoff expectation message to the communication device 300. Here, the handoff expectation message may be a message for notifying that handoff of the user terminal 100 is imminent. A received signal strength indication (RSSI) may be used to determine whether handoff is imminent. When a value of the RSSI is smaller than a preset reference value, the communication interruption prevention unit 120 may determine that handoff is imminent and transmit the handoff expectation message to the communication device 300. Any information besides the RSSI may be used to determine whether handoff is imminent.

The communication device 300 includes a zone information management unit 310 and a communication interruption prevention unit 320. In order to differentiate between the two, the communication interruption prevention unit 120 of the user terminal 100 may be referred to as a communication interruption prevention unit for a terminal and the communication interruption prevention unit 320 of the communication device 300 may be referred to as a communication interruption prevention unit for a device. The zone information management unit 310 receives the zone information. This zone information may have been transferred from the user terminal 100. The zone information management unit 310 stores and manages the received zone information in a memory. The zone information managed by the communication device 300 may exist for each user terminal. Therefore, to differentiate between the zone information, an ID of the user terminal 100 may be matched to the zone information to manage the zone information.

The communication interruption prevention unit 320 may identify other access nodes that are candidate handoff targets of the user terminal 100 based on the zone information stored in the memory. When there is a message to be transmitted to the user terminal 100, the communication interruption prevention unit 320 may make as many duplicates of the message as the number of the identified other access nodes and transmit the duplicate messages. Here, the communication interruption prevention unit 320 may also transmit the message to the access node 200. When the message is duplicated and transmitted, the communication interruption prevention unit 320 may mark, on a head of the message, a flag indicating flooding. That is, the communication interruption prevention unit 320 transmits a zone-flooding message to a plurality of nodes.

In one embodiment, when there is a message to be transmitted, the communication interruption prevention unit 320 does not unconditionally transmit the message to all of the other access nodes, but may transmit the message to the other access nodes only when the handoff expectation message is received from the user terminal 100. Since the message is transmitted to the other access nodes only when the handoff expectation message is received, waste of network resources can be prevented.

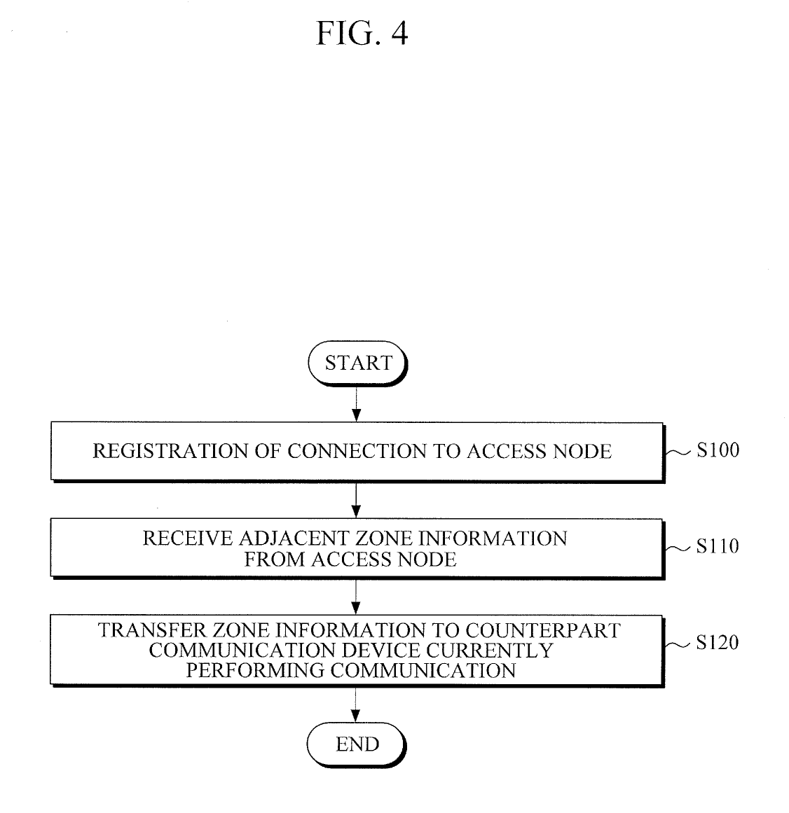

FIG. 4 is a flowchart illustrating a method of providing, by the user terminal, the zone information to the communication device that currently performs communication, according to an embodiment of the present invention.

The user terminal 100 accesses the access node (access router) 200 for connection registration (operation S100). When registered, the user terminal 100 may access the ICN through the access node 200. The access node 200 transmits the adjacent zone information to the newly registered user terminal 100. In one embodiment, the access node 200 transmits the adjacent zone information to the user terminal 100 when the user terminal 100 requests the adjacent zone information. In another embodiment, the access node 200 transmits the adjacent zone information to the user terminal 100 when the user terminal 100 is newly registered, even though the user terminal 100 does not request the adjacent zone information. The user terminal 100 receives the adjacent zone information from the access node 200 (operation S200). As described above, the zone information includes the identification information on the adjacent other access nodes that are candidate handoff targets of the user terminal 100. The user terminal 100 transfers the received zone information to the communication device 300 that currently performs communication (operation S300). Accordingly, the zone information is transferred to the communication device 300 through the access node 200.

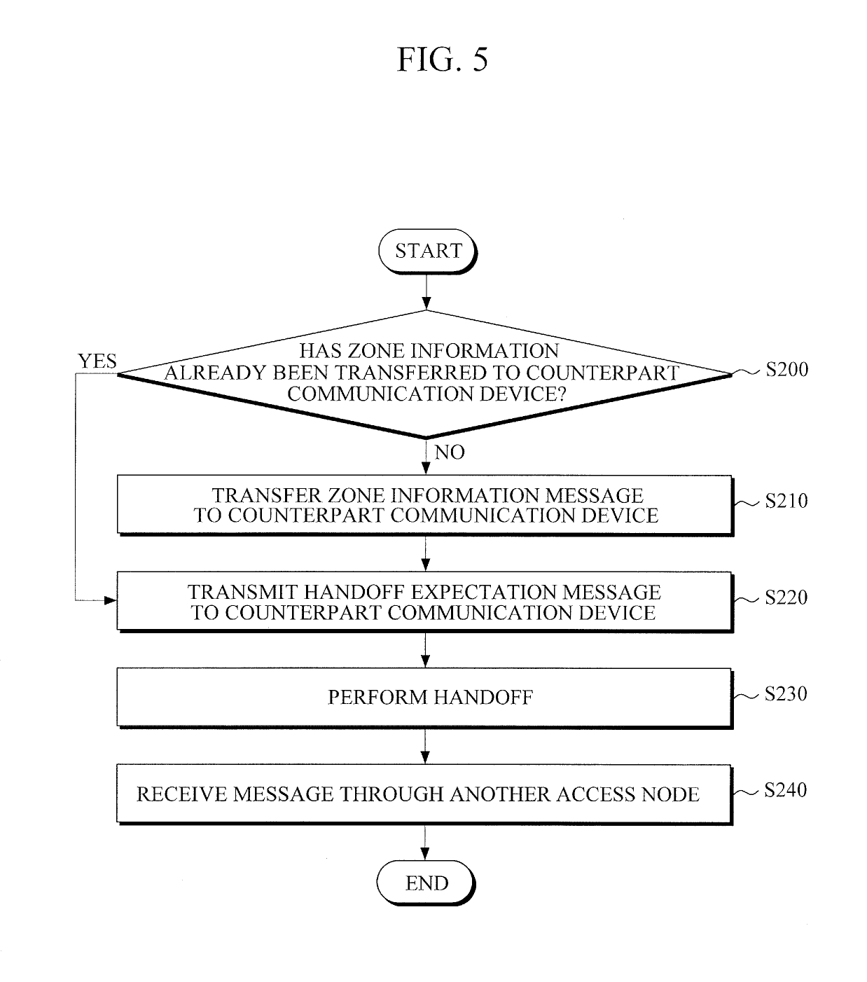

FIG. 5 is a flowchart illustrating a process during handoff of the user terminal, according to an embodiment of the present invention. When handoff is imminent, the user terminal 100 checks whether the zone information has been transferred to the communication device 300 (operation S200). If the zone information has not been transferred, the user terminal 100 transfers the zone information to the communication device 300 (operation S210), and then transfers the handoff expectation message to the communication device 300 (operation S220). If the zone information has already been transferred, the user terminal 100 directly performs operation S220. Thereafter, the user terminal 100 performs handoff (operation S230), and receives a message through another access node 200 when the communication device 300 transmits the message to the user terminal 100 (operation S240).

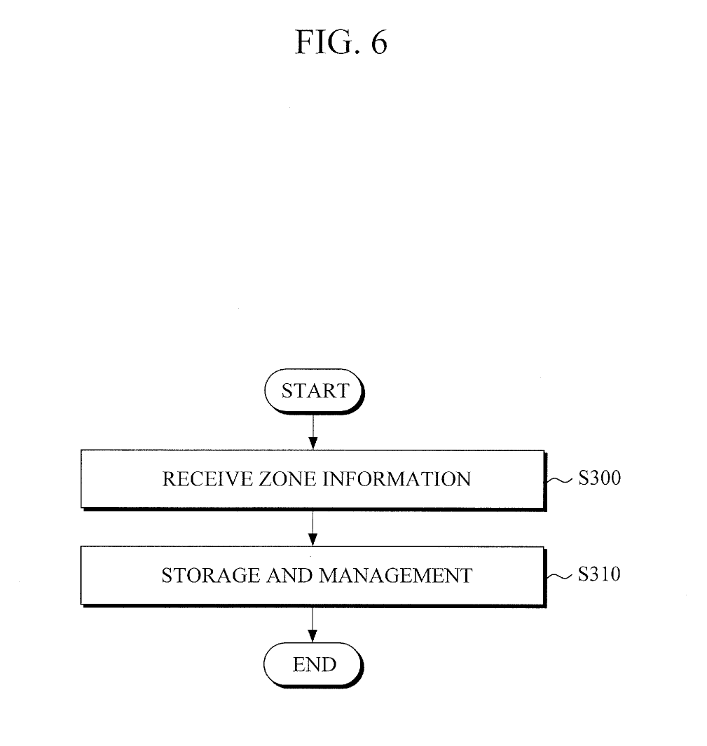

FIG. 6 is a flowchart illustrating a method of receiving and storing, by the communication device, the zone information, according to an embodiment of the present invention.

The communication device 300 that is communicating with the user terminal 100 receives the zone information (operation S300). Here, the zone information includes the identification information on the adjacent other access nodes that are candidate handoff targets of the user terminal 100. In one embodiment, this zone information is transferred from the user terminal 100. In another embodiment, the zone information may be directly transferred from the access node 200. The communication unit 300 stores and manages the received zone information in a memory (operation S310). Here, the zone information may be matched to an ID for identifying the user terminal 100 in order to be stored.

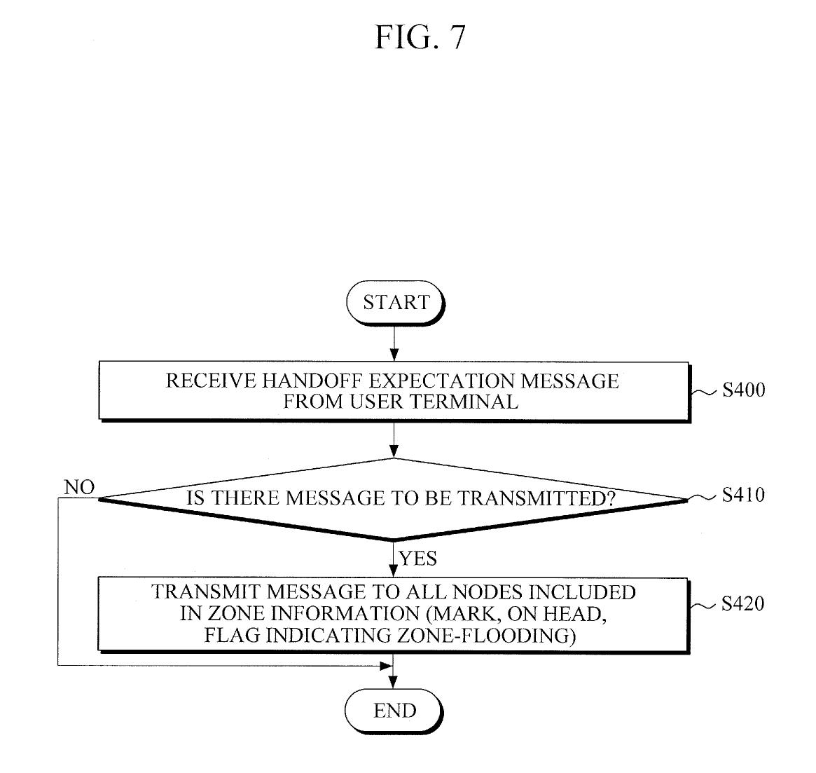

FIG. 7 is a flowchart illustrating a method of transmitting, by the communication device, a message to the user terminal using the zone information, according to an embodiment of the present invention. The communication device 300 receives the handoff expectation message from the user terminal 100. When the handoff expectation message is received, the communication device 300 checks whether there is a message to be transmitted to the user terminal 100 (operation S410). If the message exists, the communication device 300 checks the zone information stored in the memory to identify the other access nodes, and transmits the message to the identified other access nodes (operation S420). Here, the communication device 300 may mark, on a head of the message, a flag indicating zone-flooding to transmit the message. Operation 5400 illustrated in FIG. 7 may be omitted.

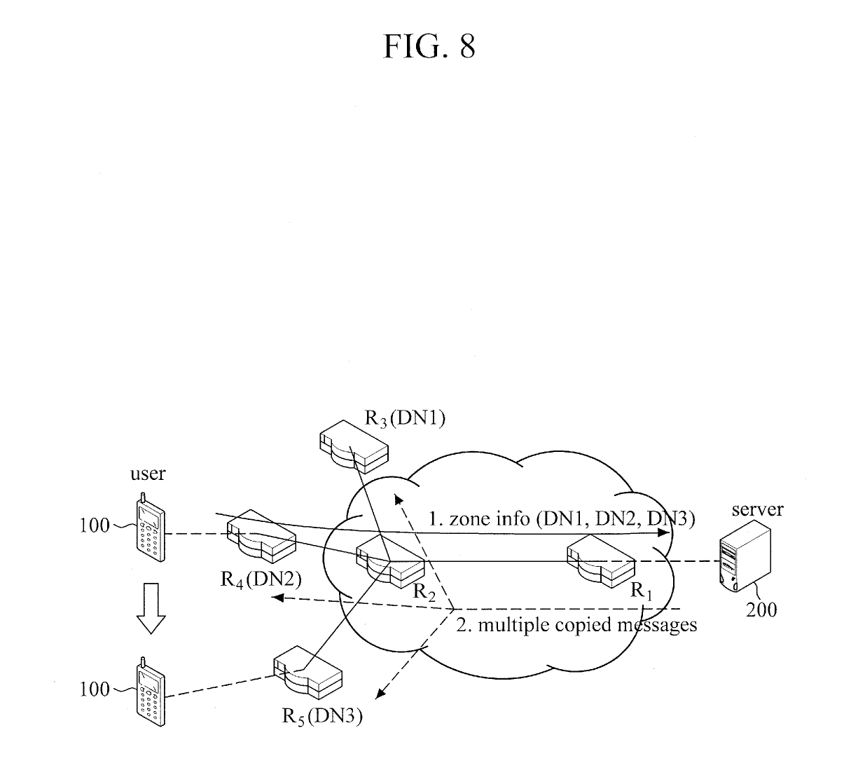

FIG. 8 is a diagram illustrating a scenario for preventing communication interruption during handoff, according to an embodiment of the present invention.

A specific example will be described with reference to FIG. 8. In FIGS. 8, R1, R2, R3, R4, and R5 are intermediate relay router nodes. FIG. 8 illustrates that the user terminal 100 is connected to the access node 200 and then moves to another access node, i.e., the node R5. The user terminal 100 receives the adjacent zone information from the node R4. Herein, the received zone information may be {DN1, DN2, DN3}. The user terminal 100 transfers the received zone information to the communication device 300.

The user terminal 100 may transmit the interest message to the communication device (server) 300 while being connected to the router R4. The communication device 300 may transmit a response message for the interest message to the user terminal 100. Here, an example of the response message is R4/user/response. However, if the user terminal 100 moves from the node R4 to the node R5 after transmitting the interest message, the user terminal 100 cannot receive the response message transferred through the node R4. Therefore, the communication device 300 transmits the response message to all of the nodes R3 to R5 according to the zone information with the mark on the head of the message for indicating zone-flooding. Here, a message of R3/R4/user/response is transmitted to the node R3, and a message of R5/R4/user/response is transmitted to the node R5. That is, since an original response message is R4/user/response, domain information is attached to the front of router information in order to be transferred in the format of zone/Router/user/response. However, in the case of the node R4, the message may be directly transferred in the format of R4/user/response or may be transferred in the format of R4/R4/user/response. This is because the message is originally directed to the node R4, and thus the node R4 is able to normally operate even though the message is not transferred in the zone-router format. In this manner, the response message may be normally received from the communication device 300 even though the user terminal 100 moves to the node R5.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A user terminal for preventing communication interruption during handoff in an information-centric network, comprising:
a connection registration unit configured to register the user terminal in an access node for a connection to the access node; and
a communication interruption prevention unit configured to receive, from the access node in which the user terminal is registered, zone information comprising identification information on other access nodes that are candidate handoff targets of the user terminal, and transfer the zone information to a counterpart communication device that currently performs communication,
wherein the user terminal receives a message from the counterpart communication device through one of the other access nodes that are candidate handoff targets during the handoff.

2. The user terminal of claim 1, wherein the communication interruption prevention unit transmits a handoff expectation message to the counterpart communication device.

3. A communication device for preventing communication interruption during handoff of a user terminal in an information-centric network, comprising:
a zone information management unit configured to receive and manage zone information comprising identification information on other access nodes that are candidate handoff targets of the user terminal; and
a communication interruption prevention unit configured to identify the other access nodes based on the received zone information, and transmit, to the identified other access nodes, a message to be transferred to the user terminal.

4. The communication device of claim 3, wherein the communication interruption prevention unit transmits the message to be transferred to the user terminal when a handoff expectation message is received from the user terminal.

5. The communication device of claim 3, wherein the communication interruption prevention unit marks, on the message, a flag indicating flooding when transmitting the message.

6. A method of preventing communication interruption during handoff of a user terminal in an information-centric network, comprising:
receiving, from an access node in which the user terminal is registered for connection to the access node, adjacent zone information comprising identification information on adjacent other access nodes;
transferring the received zone information to a counterpart communication device that currently performs communication; and
receiving a message from the counterpart communication device through one of the other access nodes identified based on the zone information during the handoff.

7. The method of claim 6, wherein the adjacent other access nodes are adjacent nodes that are candidate handoff targets of the user terminal.

8. The method of claim 6, further comprising transmitting a handoff expectation message to the counterpart communication device.

9. A method of preventing, by a communication device, communication interruption during handoff of a user terminal in an information-centric network, comprising:
receiving zone information comprising identification information on other access nodes that are candidate handoff targets of the user terminal; and
transmitting, to the other access nodes identified based on the received zone information, a message to be transferred to the user.

10. The method of claim 9, wherein the receiving of the zone information comprises receiving the zone information transmitted from the user terminal.

11. The method of claim 9, further comprising receiving a handoff expectation message from the user terminal, wherein the transmitting of the message is performed when the handoff expectation message is received.

12. The method of claim 9, wherein the transmitting of the message comprises marking, on the message, a flag indicating flooding.
